(19) United States
(12) Patent Application Publication
(10) Pub. No.: US 2006/0182904 A1
(43) Pub. Date: Aug. 17, 2006

(54) Ink-jet recording sheet

(75) Inventors: Masayuki Ushiku, Yokohama-shi (JP); Manabu Kaneko, Tokyo (JP); Shinsaku Kashiwamura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 11/352,065

(22) Filed: Feb. 10, 2006

(30) Foreign Application Priority Data
Feb. 16, 2005 (JP) JP2005-038950
Dec. 6, 2005 (JP) JP2005-351790

(51) Int. Cl. B41M 5/00

(52) U.S. Cl. 428/32.24

(57) ABSTRACT

An ink-jet recording sheet containing a support having thereon at least two porous ink absorptive layers containing microparticles and a hydrophilic resin, wherein an uppermost ink absorptive layer has a smaller average void diameter than an ink absorptive layer adjacent to the uppermost ink absorptive layer, and the hydrophilic resin in the uppermost ink absorptive layer is cross-linked by irradiation with ionization radiation.

This application is based on Japanese Patent Application Nos. 2005-038950 filed on Feb. 16, 2005 and 2005-351790 filed on Dec. 6, 2005 in Japanese Patent Office, the entire content of which is hereby incorporated by reference.

### TECHNICAL FIELD

The present invention relates to a novel ink-jet recording sheet.

In recent years, ink-jet recording systems have been subjected to attempts for rapid enhancement of image quality which approaches conventional photographic quality. On the other hand, however, printing rates have been much enhanced. In such circumstance, importance of the quality of ink-jet recording sheets for final print quality has greatly increased. Developed as one example of ink-jet recording sheets capable of forming high quality ink-jet recording images is a porous ink-jet recording sheet in which a porous layer, exhibiting a void structure, is formed by combining minute inorganic particles such as silica or alumina with a small amount of water-soluble polymers as a binder. This porous ink-jet recording sheet exhibits two features in which ink is quickly absorbed into the void portions via capillary phenomena and it is possible to maintain a large amount of ink in the interior of the void portions, since void portions are incorporated in the ink absorptive layer. The above features result in desired drying property and rapid ink absorption, whereby printed ink dots maintain an almost circular shape, resulting in an advantage of production of images of superior distinctness.

The current situation is that generally, porous ink-jet recording sheets produce printed images of high distinctness, while the glossiness is not yet high enough.

In order to improve the glossiness, known is an ink jet-recording sheet which incorporates a smoothness-provided resin-coated support which is prepared by covering both sides of a paper substrate with polyethylene resins, having thereon a coated porous ink absorptive layer. Disclosed as one example of such a porpus type ink-jet recording sheet is an ink-jet recording sheet which incorporates a support having thereon an ink absorptive layer comprising silica as minute inorganic particles, polyvinyl alcohol as a hydrophilic binder, and boric acid or salts thereof as a crosslinking agent (refer, for example, to Patent Documents 1 and 2).

Glossiness is enhanced by employing the aforesaid resin-coated paper. In order to enhance smoothness of the support, it becomes necessary to apply a relatively thick polyethylene resin layer onto the support, resulting in increased cost. Further, when a support is smoothened only employing the above method, it is not possible to sufficiently improve the glossiness of the ink-jet recording sheets coated with a porous ink absorptive layer.

Further, in recent years, many attempts have been conducted to have ink-jet recorded image quality approach that of conventional photography. The most important factor to enhance image quality regarding printed dots is that each of the dots is not discernible by the naked eye. To achieve this aim, the main factors are that the size of ink droplets is reduced, or a dye ink of a lower concentration is simultaneously employed so that the reflection density of dots in the highlight portion is lowered whereby dots are barely discernible.

Under such circumstances, the amount of ink droplets ejected during image formation tends to increase. Consequently, the ejected ink overflows due to insufficient ink absorption capacity of the ink jet recording sheet, whereby degradation of image quality and drying properties have been noted.

In order to overcome the above drawbacks, when the porous ink absorptive layer thickness is increased, cracking tends to occur due to its coating characteristics, or the coating rate is lowered due to the drying capacity, whereby problems such as an increase in production cost result.

As a means to solve the above problems, a method is listed in which the diameter of each ink droplet is enlarged, whereby it is possible to decrease the ink amount which is required to form the necessary dot size. For example, when the magnification ratio of dots on an ink-jet recording sheet is increased by 10 percent, it is possible to decrease the necessary ink amount for image formation by approximately 25 percent, and at the same time, it is possible to reduce the ink absorption capacity of the ink-jet recording sheet, resulting in an advantage in terms of print cost. Further, since it is possible to decrease the thickness of the aforesaid porous ink absorptive layer, production advantages result such as reduction of cracking which is a drawback of porous ink-jet recording sheets, and reduction of drying load. However, it has been difficult to overcome the drawback to increase the dot magnification ratio, while maintaining the desired high ink absorbability.

(Patent Document 1) Japanese Patent Publication Open to Public Inspection (hereinafter referred to as JP-A) No. 10-119423

(Patent Document 2) JP-A No. 2000-218927

### SUMMARY

In view of the foregoing, the present invention was achieved. An object of the present invention is to provide an ink-jet recording sheet which exhibits the enhanced glossiness while maintaining a high ink absorption rate, and which is capable of enhancing the dot magnification ratio with respect to ink droplets.

The above object of the present invention is achievable employing the following embodiments.

(1) One of the embodiments of the present invention includes an ink-jet recording sheet comprising a support having thereon at least two porous ink absorptive layers comprising microparticles and a hydrophilic resin,

wherein an uppermost ink absorptive layer has a smaller average void diameter than an ink absorptive layer adjacent to the uppermost ink absorptive layer, and the hydrophilic resin in the uppermost ink absorptive layer is cross-linked by irradiation with ionization radiation.

(2) Another embodiment of the present invention includes an ink-jet recording sheet of the above-described item 1,

wherein a thickness of the uppermost ink absorptive layer is from 0.03 to 1.00 μm.

(3) Another embodiment of the present invention includes an ink-jet recording sheet of any one of the above-described items 1 or 2,

wherein the hydrophilic resin in the uppermost ink absorptive layer has a degree of polymerization of not less than 300 and comprises a main chain and a plurality of side chains, and the side chains are cross-linked with each other by irradiation with ultraviolet radiation.

(4) Another embodiment of the present invention includes an ink-jet recording sheet of any one of the above-described items 1 to 3,

wherein an average particle diameter of the microparticles in the uppermost ink absorptive layer is not more than 100 nm, and the microparticles are silica or a polymer.

(5) Another embodiment of the present invention includes an ink-jet recording sheet of any one of the above-described items 1 to 4,

wherein the microparticles in the uppermost ink absorptive layer are colloidal silica.

(6) Another embodiment of the present invention includes an ink-jet recording sheet of any one of the above-described items 1 to 5,

wherein the uppermost ink absorptive layer is produced by a method comprising the steps of:

(a) applying an ink absorptive layer composition comprising the microparticles, hydrophilic resin and a solvent onto the support;

(b) irradiating the applied ink absorptive layer composition with ionization radiation while the applied ink absorptive layer composition is wet; and

(c) drying the irradiated ink absorptive layer composition.

By the present invention, it was possible to provide an ink-jet recording sheet which exhibits the enhanced glossiness while maintaining a high ink absorption rate, and which is capable of enhancing the dot magnification ratio with respect to ink droplets.

### DESCRIPTION OF THE PREFERRED EMBODIMENTS

The preferred embodiments to practice the present invention will now be detailed.

In view of the above problems, the inventors of the present invention conducted diligent investigations and discovered the following:

By employing an ink-jet recording sheet characterized in incorporating a support having thereon at least two porous ink absorptive layers, containing microparticles, and hydrophilic resins in which the average void diameter of the uppermost porous ink absorptive layer is less than that of the adjacent porous ink absorptive layer and the uppermost porous ink absorptive layer incorporates hydrophilic resins crosslinked by ionization radiation, it was possible to achieve the enhanced glossiness while maintaining the high ink absorption rate, as well as to enhance the dot magnification ratio with respect to ink droplets.

Namely, in regard to enhancement of the dot magnification ratio per ink droplet, which is the object of the present invention, diligent investigations were conducted. As a result, it was discovered that it was possible to enhance the dot magnification ratio by performing such a design that the average void diameter of the uppermost porous ink absorptive layer which was farthest from the support was less than that of the adjacent porous ink absorptive layer, employing an ink-jet recording sheet which incorporated a support having thereon at least two porous ink absorptive layers.

Examples of methods to result in differences in the average void diameter between the upper and lower porous ink absorptive layers as described above include:

1) A method in which in a group of porous ink absorptive layers consisting of an uppermost layer comprising at least microparticles and a lower layer comprising at least microparticles as well as a small amount of hydrophilic resins, the diameter of particles which are employed to prepare voids in the uppermost layer is controlled to be less than that of the microparticles in the lower porous ink absorptive layer.

2) A method in which in a group of porous ink absorptive layers as described above, particles, such as minute polymer particles or colloidal silica, which relatively tend to not form voids, are employed in the upper layer, while porous particles represented by vapor phase method silica or wet method silica, which tend to form relatively large voids are employed in the lower layer.

3) A method in which in a group of porous ink absorptive layers as described above, the ratio of hydrophilic resins to microparticles of the uppermost layer is set to be higher than that of the lower layer.

4) A method in which after applying at least two porous ink absorptive layers, voids of the uppermost layer are sealed employing a physical means such as a calendaring treatment.

By appropriately selecting any of the above methods, it is possible to enhance the dot magnification ratio. However, the method in which the average void diameter differs between the above-mentioned uppermost layer and lower layer results in problems in which ink absorbability decreases.

As a method to enhance ink absorbability, it is generally known to employ crosslinking agent. However, sufficient effects have not been achieved by employing only crosslinking agents. For example, in cases in which boric acid and borax, which are widely used in porous ink-jet recording sheets in which the average void diameter differs between the aforesaid uppermost layer and lower layer, are employed as the crosslinking agent, a sufficient ink absorption rate is not obtained, whereby mottled images or bronzing results.

In order to overcome the above drawbacks, diligent investigations were conducted. As a result, in ink absorptive layers in which the average void diameter of the uppermost layer was less than that of the lower layer, by incorporating hydrophilic resins which had undergone crosslinking by ionization radiation into the uppermost porous ink absorptive layer, it became possible to achieve both enhancement of the dot magnification ratio and enhancement of ink absorbability, whereby the present invention was achieved. Specifically, when the hydrophilic resins underwent crosslinking by ionization radiation, even during storage after coating, it was noted that stable dot magnification effect resulted and in addition, the glossiness was enhanced due to high smoothness of the layer surface.

A clear understanding has not yet achieved for the enhancement of ink absorbability due to crosslinking by ionization radiation, nor of the achievement of stable dot magnification effects and the enhancement of glossiness. However, the following assumption has been made.

Inorganic crosslinking agents such as boric acid or borax undergo reversible crosslinking with respect to water. As a result, during the ink penetrating process after printing, the crosslinking structure is modified, whereby the resulting absorption rate is lowered due to sealing of voids by swelling of hydrophilic resins. On the other hand, when crosslinking is performed by ionization radiation, the crosslinking structure does not change in the presence of water, namely irreversible crosslinking during the ink penetrating process, sealing of voids due to swelling of the hydrophilic resins or diffusion into the lower layer barely occurs, whereby it is assumed that it is possible to achieve a higher absorption rate. Further, compared to a crosslinking means in which crosslinking is achieved via heat, when the crosslinking is conducted by ionization radiation, the crosslinking state barely changes during storage after coating, whereby it is assumed that it is possible to obtain a stable dot diameter and the desired absorption rate.

Reasons for the enhancement of glossiness in the case of crosslinking by ionization radiation are assumed to be as follows. Namely, it is assumed that since it is possible to form a highly elastic layer by crosslinking and gelling a porous ink absorptive layer liquid coating composition in a wet state on a support after coating, employing ionization radiation, it is possible to retard the formation of an uneven layer surface due to drying air. Consequently, it is assumed that the smoothness of layer surface is improved, whereby it is possible to result in the enhanced glossiness. On the other hand, a method is also useful in which gelling is performed at a low temperature, employing inorganic crosslinking agents such as boric acid or borax. However, since the crosslinking reaction is reversible with respect to temperature, elasticity of the layer decreases along with an increase in layer surface temperature and it is not possible to result in sufficient drying air resistance, whereby it is not possible to achieve the desired glossiness.

Further, it is, in principle, possible to gel a liquid coating composition in the same manner as above by crosslinking hydrophilic resins employing organic crosslinking agents such as glyoxal or epoxy. However, it is not possible to perform crosslinking reaction and gelling in the earliest stage after coating, whereby the effect to result in the desired glossiness of the coating has not been realized.

The present invention will now be detailed.

The ink-jet recording sheet of the present invention incorporates a support having thereon a multilayered structure formed by laminating at least two porous ink absorptive layers (hereinafter also referred to as void layers), having a large void volume, comprising microparticles and hydrophilic resins, in which the outer most layer is formed in the farthest position from the support.

The porous layer, as described in the present invention, refers to the layer which forms a large void volume employing microparticles and hydrophilic resins, while the ink absorptive layer, as described in the present invention, refers to a layer which exhibits any absorption capability in terms of a broad definition.

In the ink-jet recording sheet of the present invention, one of the features is that the average void diameter of the uppermost porous layer is less than that of the adjacent porous layer. The average void diameter of the porous ink absorptive layer according to the present invention is determined as follows. The surface and cross-section of a porous ink absorptive layer are observed employing an electron microscope and the diameter of each of at least 100 randomly selected voids is determined. Then, a simple average value (being a number average) is obtained. Herein, each of the void diameters is represented by the diameter of a circle which has the same area as the projective area of the void.

In the ink-jet recording sheet of the present invention, it is characterized that in an ink-jet recording sheet which incorporates a support having thereon at least two laminated porous ink absorptive layers of a high void volume, which are comprising microparticles and hydrophilic resins, the uppermost layer incorporates hydrophilic resins which have undergone crosslinking by ionization radiation.

The hydrophilic resins employed in the porous ink absorptive layer according to the present invention will now be described.

Hydrophilic resins which are applicable to the porous ink absorptive layer according to the present invention are not particularly limited, and it is possible to employ conventional hydrophilic binders such as gelatin, polyvinylpyrrolidone, polyethylene oxide, polyacrylamides, or polyvinyl alcohol. Of these, polyvinyl alcohol is particularly preferred in view of relatively low moisture sorption as a binder, a lower degree of curling of recording sheets, higher inorganic particle binding capability in use of a smaller amount, fewer cracks, and excellent layer adhesion.

Polyvinyl alcohols preferably employed in the present invention include, other than common polyvinyl alcohol prepared by hydrolyzing polyvinyl acetate, modified polyvinyl alcohols such as polyvinyl alcohol in which chain terminals have undergone cationic modification or anion-modified polyvinyl alcohol having an anionic group.

Preferably employed as polyvinyl alcohol prepared by hydrolyzing vinyl acetate are those having an average degree of polymerization of at least 300, but those having an average degree of polymerization of 1,000-5,000 are particularly preferably employed. Those having a saponification ratio of 70-100 percent are preferred, while those of 80-99.8 percent are particularly preferred.

Listed as a cation-modified polyvinyl alcohol is one having a primary, secondary, or tertiary amino group, or a quaternary amino group on the main or branched chain of the above polyvinyl alcohol, as described, for example, in JP-A No. 61-10483. This is prepared by saponifying a copolymer of ethylenic unsaturated monomers, having a cationic group, with vinyl acetate.

Listed as ethylenic unsaturated monomers having a cationic group are, for example, tri-methyl-(2-acrylamido-2,2-dimethylethyl)ammonium chloride, trimethyl-(3-acrylamido-3,3-dimethylpropyl)ammonium chloride, N-vinylimidazole, N-methylvinylimidazole, N-(3-dimethylaminopropyl)methacrylamide, hydroxyethyltrimethylammonium chloride, and trimethyl-(3-methacrylamidopropyl)ammonium chloride.

The ratio of monomers having a cation-modified group of the cation-modified polyvinyl alcohol is commonly 0.1-10 mol percent with respect to vinyl acetate, but is preferably 0.2-5 mol percent.

Listed as anion-modified polyvinyl alcohols are, for example, polyvinyl alcohol having an anionic group, described in JP-A No. 1-206088, copolymers of vinyl alcohol with vinyl compounds having a water-solubilizing group, described in JP-A Nos. 61-237681 and 63-307979, and modified polyvinyl alcohol having a water-solubilizing group, described in JP-A No. 7-285265.

Further listed as nonion-modified polyvinyl alcohols are, for example, polyvinyl alcohol derivatives partially added with a polyalkylene oxide group, described in JP-A No. 7-9758, and block copolymers of polyvinyl alcohol with hydrophobic group-containing vinyl compounds, described in JP-A No. 8-25795.

It is possible to simultaneously use at least two polyvinyl alcohols which differ in degree of polymerization or type of modification. Specifically, in the case of the use of polyvinyl alcohol at a degree of polymerization of at least 2,000, it is preferable that polyvinyl alcohol at a degree of polymerization of at least 2,000 is initially added to minute inorganic particles in an amount of 0.05-10 percent by weight with respect to the minute organic particles, but preferably 0.1-5 percent by weight, and subsequently, the above polyvinyl alcohol is added, resulting in no marked increase in viscosity.

The porous ink absorptive layer according to the present invention is characterized in that the uppermost layer incorporates hydrophilic resins which have undergone crosslinking by ionization radiation.

The hydrophilic resins (hereinafter also referred to as polymer compounds) which have undergone crosslinking by ionization radiation, as described herein, refer to water-soluble resins which undergo reaction by exposure to ionization radiation such as ultraviolet radiation or electron beams, resulting in a crosslinking or polymerization reaction, and which are water-soluble resins prior to the reaction but become substantially water-insoluble resins after the reaction. The above resins exhibit hydrophilicity after the reaction and maintain sufficient affinity to ink.

Such resins include a type selected from the group consisting of saponified polyvinyl acetate products, polyvinyl acetal, polyethylene oxide, polyalkylene oxide, polyvinylpyrrolidone, polyacrylamide, hydroxyethyl cellulose, methyl cellulose, hydroxypropyl cellulose, derivatives of the above hydrophilic resins, and copolymers thereof, or those which are prepared by modifying the above hydrophilic resins employing a modifying group of a photodimerization type, a photodecomposition type, a photopolymerization type, a photomodification type, or a photodepolymerization type. Of these, in view of photographic speed and stability of resins themselves, preferred are resins which are modified by a modifying group of the photodimerization type or the photopolymerization type. Preferred as photodimerization type modifying groups are those to which a diazo group, a cinnamoyl group, a styrylpyridinium group, or a stylquinolium group, has been introduced, but resins are preferred which are dyed with water-soluble dyes, such as an anion dye, after photodimerization. Examples of such resins include resins incorporating a cationic group such as a primary amino group or a quaternary ammonium group, such as photosensitive resins (compositions) described in JP-A Nos. 62-283339, 1-198615, 60-252341, 56-67309, and 60-129742, as well as resins which become cationic after curing in such a manner that an azido group is modified to an amino group via a curing treatment, such as photosensitive resins (compositions) described in JP-A No. 56-67309. Of these, preferred are polymer compounds in which, by exposing ultraviolet radiation to hydrophilic polymer compounds at a degree of polymerization of at least 300 having a plurality of side chains on the main chain, crosslinking between the side chains results.

Listed as specific examples are the following compounds, however the present invention is not limited thereto.

The photosensitive resins described in JP-A No. 56-67309 are resin compositions contain a structure represented by following Formula (I).

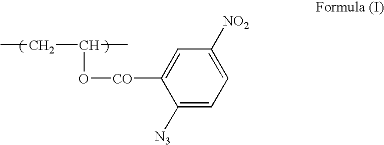

The structure is a 2-azido-nitrophenylcarbonyloxyethylene structure. Or the resin composition contain a structure represented by following Formula (II).

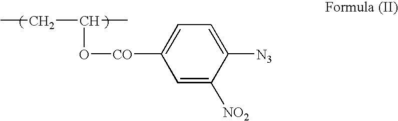

The structure is a 4-azido-nitrophenylcarbonyloxyethylene structure.

Specific examples of the photosensitive resins are described in Examples 1 and 2 of the above patent and constituting components of the photosensitive resins and their use ratio are described on page 2 of the above patent.

Further, in JP-A No. 60-129742, listed are resin compositions having the following structure represented by Formulas (III) and (IV) in a polyvinyl alcohol structure as a photosensitive resin.

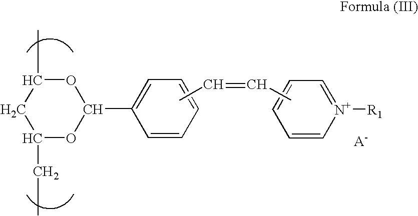

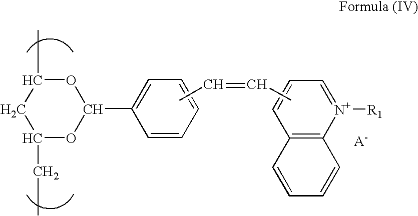

In the present invention, of hydrophilic resins which undergo crosslinking by ionization radiation in view of reactivity preferred as a photopolymerization type modifying group, are polyvinyl acetate saponifying products having the constituting unit represented by following Formula (A), disclosed, for example, in JP-A No. 2000-181062.

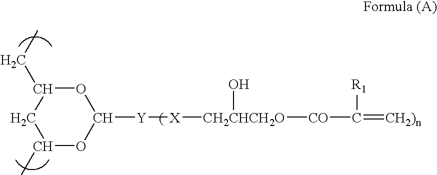

In above Formula (A), R₁ represents a hydrogen atom or a methyl group; Y represents an aromatic ring, or a simple bonding means; X represents —(CH₂)ₘ—COO—, —O—CH₂—COO— or —O—; m represents an integer of 0-6; and n represents 1 or 2.

Further, hydrophilic resins such as gelatin, polyvinylpyrrolidone, polyethylene oxide, polyacrylamides, or polyvinyl alcohol may be simultaneously employed together with the above hydrophilic polymer compounds at a degree of polymerization of at least 300, having a plurality of side chains on the main chain.

In the present invention, it is preferable to add photoinitiators or sensitizers together with hydrophilic binders incorporating polymer compounds polymerized by ionization radiation. These compounds may be dissolved in solvents or may be in a dispersed state, or may be chemically combined with hydrophilic binders incorporating the above polymer compounds.

Employed photoinitiators and photosensitizers are not particularly limited, and it is possible to employ any of the conventional photoinitiators and photosensitizers known in the art. Examples include benzophenones (for example, benzophetone, hydroxybenzophenone, bis-N,N-dimethylaminobenzophenone, bis-N,N-diethylaminobenzophenone, and 4-methoxy-4′-dimethylaminobenzophenone); thioxanthones (for example, thioxanthone, 2,4-diethylthioxanthone, isopropylthioxanthone, chlorothioxanthone and isoproxychlorothioxanthone); anthraquinones (for example, ethylanthraquinone, benzanthraquinone, aminoanthraquinone, and chloroanthraquinone); acetophenones; benzoin ethers (for example, benzoin methyl ether); 2,4,6-trihalomethyltriazines; 1-hydroxycyclohexyl phenyl ketone; 2-(o-chlorophenyl)-4,5-diphenylimidazole dimers, 2-(o-chlorophenyl)-4,5-di(m-methoxyphenyl)imidazole dimers, 2-(o-chlorophenyl)-4,5-di(m-methoxyphenylimidazole dimers, 2-(o-methoxyphenyl)-4,5-phenylamidazole dimers, 2-(p-methoxyphenyl)-4,5-diphenylimidazole dimers, 2,-di(p-methoxyphenyl)-5-phenylimidazole dimers, 2-(2,4-dimethoxyphenyl)-4,5-diphenylimidazole dimers, 2,4,5-triarylimidazole dimers; benzyl methyl ketal, 2-benzyl-2-dimethylamino-1-(4-morpholinophenyl)-betane-1-one, 2-methyl-1-[4-(methylthio)phenyl]-2-morpholino-1-propane, 2-hydroxy-2-methyl-1-phenyl-propane-1-one, 1-[4-(2-hydroxyethoxy)-phenyl]-2-hydroxy-2-methyl-1-propane-1-one, phenantholenequinone, 9,10-phenantholenequinone, benzoins such as methylbenzoin, or ethylbenzoin; acridine derivatives (for example, 9-phenylacridine and 1,7-bis(9,9′-acrydinyl)heptane); and bisacylphosphine oxide, as well as mixtures thereof. The above compounds may be employed individually or in combinations of at least two types.

Specifically, in view of enhanced mixing properties and crosslinking efficiency, preferred are water-soluble initiators such as 1-[4-(2-hydroxyethoxy)-phenyl]-2-hydroxy-2-methyl-1-propane-1-one, 4-(2-hydroxyethoxy)-phenyl-(2-hydroxy-2-propyl)ketone, thioxanthone ammonium salts, or benzophenone ammonium salts.

In addition to these initiators, it is possible to incorporate accelerators. Listed as examples of these are isoamyl p-dimethylaminobenzoate, ethanolamine, diethanolamine, and triethanolamine.

In such resins, the degree of polymerization of mother nucleolus polyvinyl alcohol resins is preferably at least 300, but is more preferably at least 1,700. The modification ratio of an ionization radiation reacting modifying group with respect to the segment is preferably at most 4 mol percent, but is more preferably at most 1 mol percent. When the degree of polymerization of the segment exceeds 300 or the modification ratio exceeds 4 mol percent, creasing and cracking of a dried coating markedly increase due to excessively high crosslinking density of the coating. When the crosslinking density is excessively high, the balance of moisture absorption and dimensional stability to a substrate is also degraded, resulting in degradation of curling resistance. Consequently such cases are not preferred.

In the production method of the ink-jet recording sheet of the present invention, in cases in which the above polymer compounds by ionization radiation are employed as a hydrophilic binder, it is preferable that a liquid coating composition incorporating polymer compounds by ionization radiation is coated, and when the concentration of the entire solids in a coating reaches 5-90 percent, the coating is exposed to ionization radiating to result in gelling, and is subsequently dried.

Ionization radiation, as described in the present invention, includes, for example, electron beams, ultraviolet radiation, α-rays, β-rays, γ-rays, and X-rays. In view of safety of the operators, ease of handling, and wide industrial application, electron beams or ultraviolet radiation is preferred.

Methods of electron beam exposure include, for example, a scanning system, a curtain beam system, and a broad beam system. In view of treatment capacity, preferred is the curtain beam system. It is possible to appropriately change the acceleration voltage of electron beams depending on the specific gravity and layer pressure of the coating, while 20-300 kV is appropriate. The exposure amount of electron beams is preferably in the range of 0.1°-20 Mrad.

Employed as ultraviolet radiation sources are, for example, low, medium, or high pressure mercury lamps at an operating pressure of 100 Pa-1 MPa and metal halide lamps. In view of the wavelength distribution of radiation sources, the high pressure mercury lamps and metal halide lamps are preferred, of which the latter is more preferred.

Specifically, in cases in which ultraviolet radiation at a wavelength of at most 300 nm is included in the wavelength of radiation sources, or exposure energy exceeds 100 J/cm², the ionization radiation crosslinking mother nucleus of hydrophilic resins or various co-existing additives undergo decomposition. As a result, it is not possible to achieve the desired effects of the present invention. In addition, problems may occur such as unpleasant odors being generated due to decomposed substances. On the other hand, in cases in which exposure energy is at most 0.1 mJ/cm², it is not possible to efficiently achieve the desired effects of the present invention due to insufficient crosslinking efficiency. Consequently, it is preferable that radiation sources are provided with filters which eliminate radiation of a wavelength of at most 300 nm, while the output of lamps is preferably 400 W-30 kW, and illuminance is preferably 10 mW/cm²-10 kW/cm². In the present invention, exposure energy is preferably 0.1-100 mJ/cm², but is more preferably 150 mJ/cm².

In cases in which the same cumulative radiation amount (in mJ/cm²) is provided, the presence of preferred illuminance range is due to the fact that the transmission of the referred radiation varies. Depending on the transmittance of ultraviolet radiation, concentration distribution of generated crosslinking reaction species differs. In the case of high illuminance of ultraviolet radiation, crosslinking reaction species at a relatively high concentration are generated in the surface layer, whereby a hard and tight layer is formed in the coating surface layer. When illuminance is in the preferred range, the degree of crosslinking in the surface layer is low and radiation transmission in the depth direction is high, whereby moderate crosslinking uniformly occurs in the depth direction. In the case of excessively low illuminance, longer exposure time is required to provide necessary cumulative illuminance. As a result, it is not preferable due to the fact that not only disadvantages result in the introduction of facilities but also absolute radiation amount becomes insufficient due to scattering of ultraviolet radiation via the coating.

In view of further exhibiting of targeted effects of the present invention, it is preferable that the uppermost layer according to the present invention incorporates minute silica or polymer particles at an average diameter of at most 100 nm.

Listed as microparticles applicable to the uppermost layer are, for example, white inorganic pigments such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, vapor phase method silica, wet system silica, colloidal silica, alumina, colloidal alumina, pseudo-boehmite, aluminum hydroxide, lithopone, zeolite, and magnesium hydroxide; meso-pore containing silica synthesized employing surface active agents as a template, described in “Biryushi Kogaku Taikei (Minute Particle Engineering Series), Volume 2, page 463; minute inorganic particles such as aluminosilicate; and minute polymer particles of homopolymers and copolymers of acrylates, methacrylates, vinyl based compounds, ethylene based monomers such as styrene based monomers, or diene based compounds such as butadiene or isoprene, including as examples, acryl resins, styrene-butadiene based resins, ethylene-vinyl acetate based resins.

It is possible to employ each of the above particles in the form of a primary particle without any modification or in such a state in which secondary aggregated particles are formed.

In order to achieve high glossiness, the average diameter of microparticles employed in the uppermost layer according to the present invention is preferably at most 100 μm, but is particularly preferably at most 40 nm, whereby it is possible to achieve high glossiness, high ink absorbability, and desired effects to enhance the dot magnification ratio. The lower limit of the average particle diameter is not particularly limited, but in view of stable production of particles having the specified particle diameter, it is commonly at most 10 nm. The average diameter of microparticles is determined as follows. The cross-section and surface of a porous layer are observed employing an electron microscope and the diameter of each of 100 randomly selected particles is determined. Then, a simple average value (being a number average) is obtained. Herein, each particle diameter is represented by the diameter of a circle which has the same area as the projective area of the particle.

Further, in cases in which microparticles are incorporated in the ink absorptive layer as an uppermost layer, in view of obtaining desired color formation employing an ink, the microparticles are preferably silica or minute polymer particles. Further, in cases in which silica is employed in the ink absorptive layer as the uppermost layer, in view of necessity to decrease the void diameter, it is particularly preferable to employ colloidal silica in the uppermost layer according to the present invention.

Colloidal silica according to the present invention, as described herein, is prepared by dispersing into water silicon dioxide in a colloidal state in which particles are spherical at an average diameter of about 5 about 100 nm. Listed as colloidal silica are, for example, the SNOWTEX series available from Nissan Chemical Industries, Ltd., the KATALOID-S series available from Catalysts & Chemicals Ind. Co., Ltd., and the LEVASIL series, available from Bayer AG. Further, also preferably employed are colloidal silica which has been subjected to cationic modification employing alumina sol and aluminum hydroxide, and rosary-shaped colloidal silica which is prepared in such a manner that the primary particles of silica are linked to form a rosary employing divalent or higher valent metal ions. Listed as rosary-shaped colloidal silica are the SNOWTEX PS series and the SNOWTEX UP series available from Nissan Chemical Industries, Ltd.

The dried layer thickness of the uppermost layer, constituted as described above, is preferably in the range of 0.03-1.0 μm to make enhancement of the dot magnification ratio and ink absorbability compatible, but is more preferably in the range of 0.1-0.5 μm.

A porous ink absorptive layer excluding the uppermost layer incorporating microparticles and hydrophilic resins will now be described.

Listed as hydrophilic resins employed in the porous ink absorptive layer excluding the uppermost layer according to the present invention may be the same compounds as hydrophilic resins applicable to the above uppermost layer.

Further, listed as microparticles employed in the porous ink absorptive layer excluding the uppermost layer according to the present invention may, for example, be white inorganic pigments such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatomaceous earth, calcium silicate, magnesium silicate, vapor phase method silica, wet system silica, colloidal silica, alumina, colloidal alumina, pseudo-boehmite, aluminum hydroxide, lithopone, zeolite, and magnesium hydroxide. It is possible to employ the above minute inorganic particles in the form of a primary particle without any further modification or in the state in which secondary aggregated particles are formed.

In the present invention, to obtain high quality prints employing these ink-jet recording sheets, silica or alumina based particles are preferred since it is possible to procure those exhibiting a relatively low refractive index and having an average particle diameter of at most 100 nm at a relatively low price; alumina, pseudo-boehmite, colloidal silica, or minute silica synthesized employing a vapor phase method are preferred, but minute silica particles at an average particle diameter of at most 100 nm, synthesized employing a vapor phase method, are particularly preferred.

Silica synthesized employing the above vapor phase method may be one of which the surface is modified with aluminum. The content ratio of aluminum in the vapor phase method silica of which the surface is modified with aluminum is preferably 0.05-5 percent by weight with respect to silica.

In view of glossiness and formed color density, the diameter of the above minute inorganic particles is at most 100 nm. The lower limit of the particle diameter is not particularly limited, but in view of production of the minute inorganic particles, the diameter is preferably at least 10 nm.

The average diameter of the above minute inorganic particles is determined as follows. The cross section and surface of a porous ink absorptive layer are observed employing an electron microscope and the diameter of each of 100 randomly selected particles is determined, whereby a simple average value (being a number average) is obtained. Herein, each particle diameter is represented by the diameter of a circle which has the same area as the projective area of the particle.

The above minute inorganic particles may be present in the porous layer in the form of primary particles, or of secondary or higher order aggregated particles. The above average particle diameter refers to the diameter of independent particles in the ink absorptive layer when observed employing an electron microscope.

In cases in which the above minute inorganic particles are at least secondary aggregated particles, the average diameter of their primary particles is less than the average particle diameter observed in the porous layer. The primary particle diameter of minute inorganic particles is preferably at most 30 nm, but is more preferably 4-20 nm.

The content of the above minute inorganic particles in a water-soluble liquid coating composition is 5-40 percent by weight, but is particularly preferably 7-30 percent by weight. The above minute inorganic particles are required to form an ink absorptive layer which sufficiently absorbs ink and results in minimal layer cracking. Consequently, the coated amount in the ink absorptive layer is preferably 5-50 g/m², but is particularly preferably 10-30 g/m².

It is possible to incorporate various additives into the water-soluble liquid coating composition to form the porous layer, ink absorptive layer, or uppermost layer according to the present invention. Examples of such incorporated additives include various prior art additives such as cation mordants, polyvalent metal compounds, polystyrene, polyacrylic acid esters, polymethacrylic acid esters, polyacrylamides, polyethylene, polypropylene, polyvinyl chloride, polyvinylidene chloride or copolymers thereof, urea resins, or minute organic latex particles such as melamine resins, each of the anionic, cationic, nonionic, and amphoteric surface active agents, UV absorbers described in JP-A Nos. 57-74193, 57-87988, and 62-261476, anti-fading agents described in JP-A Nos. 57-74192, 5787989, 60-72785, 61-146591, 1-95091, and 3-13376, optical brightening agents described in JP-A Nos. 59-42993, 59-52689, 62-280069, 61-242871, and 4-219266, pH controlling agents such as sulfuric acid, phosphoric acid, citric acid, sodium hydroxide, potassium hydroxide, or potassium carbonate, anti-foaming agents, antiseptics, thickeners, antistatic agents, and matting agents.

Employed as cationic mordants are polymer mordants having a primary, secondary, or tertiary group, or a quaternary ammonium salt group. Of these, polymer mordants having a quaternary ammonium salt group are preferred since they minimize discoloration during extended storage and retard degradation of lightfastness, and further, exhibit sufficient mordant capability for dye. Preferred polymer mordants are prepared as homopolymers of monomers having the above quaternary ammonium salt group or copolymers, or condensation polymers of the above monomers with other monomers.

In the ink-jet recording sheets of the present invention, it is preferable that the ink absorptive layer specifically incorporates polyvalent metal compounds.

Listed as polyvalent metal compounds related to the present invention may, for example, be those of aluminum, potassium, magnesium, zinc, iron, strontium, barium, nickel, copper, scandium, gallium, indium, titanium, zirconium, tin, and lead. Of these, compounds comprising magnesium, aluminum, zirconium, calcium, and zinc are preferred due to their transparency. Polyvalent metal compounds incorporating zirconium atoms, aluminum atoms, or magnesium atoms are more preferred, but polyvalent metal compounds incorporating zirconium atoms are most preferred.

Compounds (excluding zirconium oxide and aluminum oxide) incorporating zirconium atoms, aluminum atoms, or magnesium atoms may be water-soluble or water-insoluble, but preferred are those which can uniformly be incorporated in the desired position of the ink absorptive layer.

Further, compounds incorporating zirconium atoms, aluminum atoms, or magnesium atoms which are usable in the present invention may be any of single salts or double salts of inorganic and organic acids, organic metal compounds, or metal complexes, but preferred are those which can uniformly be incorporated in the desired position of the ink absorptive layer.

Specific examples of zirconium atom containing compounds usable in the present invention include zirconium difluoride, zirconium trifluoride, zirconium tetrafluoride, hexafluorozirconates (for example, potassium salts), heptafluorozirconates (for example, sodium salts, potassium salts, and ammonium salts), octafluorozirconates (for example, lithium salts), zirconium fluoride oxide, zirconium dichloride, zirconium trichloride, Zirconium tetrachloride, hexachlorozirconates (for example, sodium salts and potassium salts), acid zirconium chloride (for example, zirconyl chloride), zirconium dibromide, zirconium tribromide, zirconium tetrabromide, zirconium bromide oxide, zirconium triiodide, zirconium tetraiodide, zirconium peroxide, zirconium hydroxide, zirconium sulfide, zirconium sulfate, zirconium p-toluenesulfonate, zirconyl sulfate, sodium zirconyl sulfate, acidic zirconyl sulfate trihydride, potassium zirconyl sulfate, zirconium selenate, zirconium nitrate, zirconyl nitrate, zirconium phosphate, zirconyl carbonate, ammonium zirconyl carbonate, zirconium acetate, zirconyl acetate, ammonium zirconyl acetate, zirconyl lactate, zirconyl citrate, zirconyl stearate, zirconium phosphate, zirconyl phosphate, zirconium oxalate, zirconium isopropionate, zirconium butyrate, zirconium acetylacetate, acetylacetone zirconium butyrate, stearic acid zirconium butyrate, zirconium acetate, bis(acetylacetonato)dichlorozirconium, and tris(acetylacetonato)chlorozirconium.

Of these compounds incorporating a zirconium atom, preferred are zirconyl carbonate, ammonium zirconyl carbonate, zirconyl acetate, zirconyl nitrate, acidic zirconium chloride, zirconyl lactate, and zirconyl citrate, of which particularly preferred are acidic zirconium chloride, ammonium zirconyl carbonate, and zirconyl acetate.

Specific examples of aluminum atom containing compounds usable in the present invention include aluminum fluoride, hexafluoroaluminic acid (for example, potassium salts), aluminum chloride, basic aluminum chloride (polyaluminum chloride), tetrachloroaluminates (for example, sodium salts), aluminum bromide, tetrabromoaluminates (for example, potassium salts), aluminum iodide, aluminates (for example, sodium salts, potassium salts, and calcium salts), aluminum chlorate, aluminum perchlorate, aluminum thiocyanate, aluminum sulfate, basic aluminum sulfate, aluminum potassium sulfate (alum), ammonium aluminum sulfate (ammonium alum), sodium aluminum sulfate, aluminum phosphate, aluminum nitrate, aluminum hydrogen phosphate, aluminum carbonate, aluminum silicate polysulfate, aluminum formate, aluminum acetate, aluminum lactate, aluminum oxalate, aluminum isopropionate, aluminum butyrate, ethylacetate aluminum diisopropionate, aluminum tris(acetylacetonate), aluminum tris(ethylacetacetate), and aluminum monoacetylacetonatebis(ethylacetacetonate). Of these, preferred are aluminum chloride, basic aluminum chloride, aluminum sulfate, basic aluminum sulfate, and basic aluminum sulfate silicate.

Specific examples of magnesium atom containing compounds usable in the present invention include magnesium fluoride, magnesium acetate, magnesium bromide, magnesium chloride, magnesium formate, magnesium nitrate, magnesium sulfate, magnesium thiocyanate, magnesium thiosulfate, magnesium sulfide, magnesium carbide, and magnesium phosphate. Of these, preferred are magnesium chloride, magnesium sulfate, and magnesium sulfate.

Of these polyvalent metal compounds, those which are particularly preferred are zirconyl carbonate, ammonium zirconyl carbonate, zirconyl acetate, zirconyl nitrate, acidic zirconium chloride, zirconyl lactate, zirconyl citrate, basic aluminum chloride, magnesium chloride, magnesium sulfate, and basic aluminum sulfate silicate in zirconium atom containing compounds which are exemplified as the preferred, aluminum atom containing compounds which are exemplified as the preferred, and aluminum atom containing compounds which are exemplified as the preferred. Of these, particularly preferred are acidic zirconium chloride, ammonium zirconyl carbonate, and zirconyl acetate, while acidic zirconium chloride is most preferred.

In order to minimize degradation of ink absorbability, the amount of used cationic polymers or water-soluble polyvalent metal compounds is preferably at most 10 percent by weight with respect to minute inorganic particles, but is more preferably at most 8 percent by weight.

Cationic polymers or water-soluble polyvalent metal compounds may be added employing any of the methods in which they are directly incorporated into a liquid coating composition and coated, or after coating and drying of recording sheets, an aqueous solution of cationic polymers or water-soluble polyvalent compounds is overcoated and dried.

During production of the recording sheets of the present invention, the viscosity of the ink absorptive layer liquid coating composition is preferably controlled within the range of 0.010-0.300 Pa·s at 40° C. but more preferably to 0.025-0.100 Pa·s. When the viscosity of the liquid coating composition becomes excessively high, it is not possible to feed it to a coating apparatus, resulting in problems of poor conveyance.

Suitably employed as usable supports in the present invention may be those which are known as conventional ink-jet recording sheets. They may be water absorptive supports, but non-water absorptive supports are preferred. When using absorptive supports, cockling occasionally results while a support absorbs water in the ink, whereby post-printing quality is degraded.

Listed as usable water absorptive supports in the present invention may, for example, be common paper, fabrics, and sheets or plates comprising wood. Employed as paper supports may be those prepared by using, as a main raw material, chemical pulp such as LBKP and NBKP, mechanical pulp such as GP, CGP, RMP, TMP, CTMP, VMP, or PGW, and wood pulp such as waste paper pulp including DIP. In addition, if desired, it is possible to suitably use synthetic pulp and various fibrous materials such as synthetic fibers or inorganic fibers. If desired, it is possible to incorporate, into the above paper supports, various conventional additives such as sizing agents, pigments, paper strength enhancing agents, fixing agents, optical brightening agents, wet paper strengthening agents, and cationizing agents. Paper supports are prepared using a mixture of fibrous materials such as wood pulp with various additives while employing any of the various paper making machines such as a Fourdrinier paper machine, a cylinder paper machine, or a twin wire paper machine. Further, if desired, size press treatments using starch or polyvinyl alcohol are conducted during the paper making stage or employing a paper making machines and various coating treatments as well as calender finishing may be carried out.

Non-water absorptive supports preferably usable in the present invention include transparent and opaque supports. Listed as transparent supports are films comprising materials such as polyester based resins, diacetate based resins, triacetate based resins, acryl based resins, polycarbonate based resins, polyvinyl chloride based resins, polyimide based resins, cellophane, or celluloid. Of these, preferred are those which are resistant to radiation heat when used for an overhead projector (OHP), and polyethylene terephthalate is particularly preferred. The thickness of such transparent supports is preferably 50-200 μm. Preferred as opaque supports are, for example, resin coated paper (so-called RC paper) carrying a polyolefin resin covering layer incorporating pigments on at least one side of the base paper, and so-called white PET which is prepared by incorporating white pigments such as bariums sulfate into polyethylene terephthalate. To enhance adhesion between any of the various above supports and the ink absorptive layer, it is preferable to apply a corona discharge treatment or a subbing treatment to the supports prior to coating of the ink absorptive layer. Further, the ink-jet recording sheets of the present invention need not always be colorless, but may be colored.

In the present invention, it is particularly preferred to employ, as ink-jet recording sheets, paper supports prepared by laminating both sides of a paper substrate with polyethylene, since it is thereby possible to produce at low cost high quality images approaching conventional photographic quality.

Paper supports, which are laminated with polyethylene, will now be described.

Base paper employed for a paper support is produced employing wood pulp as a main raw material, and if desired, employing synthetic pulp such as polypropylene, or synthetic fiber such as nylon or polyester. As wood pulp, for example, any of LBKP, LBSP, NBKP, NBSP, LDP, NDP, LUKP, and NUKP may be employed. However, LBKP, NBSP, LBSP, NDP, and LDP, having shorter fibers, are preferably employed in a larger proportion. However, the content proportion of LBSP or LDP is preferably from 10 to 70 percent by weight. As the above pulp, chemical pulp (sulfate salt pulp and sulfite pulp) containing minimum impurities is preferably employed, and pulp, which has been subjected to a bleaching treatment to increase whiteness, is also beneficial. It is possible to appropriately incorporate, into the base paper, sizing agents such as higher fatty acids or alkylketene dimers, white pigments such as talc or titanium oxide, paper strength enhancing agents such as starch, polyacrylamide, or polyvinyl alcohol, optical brightening agents, moisture retaining agents such as polyethylene glycol, dispersing agents, and softening agents such as quaternary ammonium. The freeness of pulp used for paper making is preferably 200-500 ml under the CSF specification, while in fiber length after beating, the sum of weight percent of 24 mesh residue and weight percent of 42 mesh residue, which are specified in JIS P 8207, is preferably 30-70 percent. Incidentally, weight percent of 4 mesh residue is preferably 20 percent by weight or less. The basic weight of base paper is preferably 30-250 g, but is more preferably 50-200 g, while the thickness of the base paper is preferably 40-250 μm. Base paper may result in high smoothness employing calender finishing during or after paper making. The density of base paper is customarily 0.7-1.2 g/cm³ (JIS P 8118). Further, the stiffness is preferably 20-200 g under conditions specified in JIS P 8153. Surface sizing agents may be applied onto the surface of base paper. The pH of base paper, when determined by the hot water extraction method specified in JIS P 8113, is preferably 5-9. Polyethylene which is employed to cover either or both surfaces of base paper is comprised of mainly low density polyethylene (LDPE) and/or high density polyethylene (HDPE). However, it is possible to partly use LLDPE and polypropylene. Specifically, preferred is a polyethylene layer, on the ink absorptive layer side, of which opacity and whiteness are improved by incorporating rutile or anatase type titanium oxide into the polyethylene as widely applied to photographic print paper. The content of titanium oxide is commonly 3-20 percent by weight with respect to polyethylene, but is preferably 4-13 percent by weight. The polyethylene-coated paper is commonly employed as a glossy paper. In the present invention, further, it is possible to use polyethylene coated matte or silk surfaced paper, which is prepared as follows. When polyethylene is coated onto the surface of base paper via melt extrusion, a matte or silk surface is formed on common photographic paper by employing so-called embossing treatments. In the above polyethylene coated paper, it is particularly preferable to maintain the moisture content of the paper in the range of 3-10 percent by weight.

During production of the ink-jet recording sheets of the present invention, it is possible to apply, onto a support, the constituting layers such as an ink absorptive layer according to the present invention, employing an appropriate method selected from conventional methods. By employing the preferred method, a liquid coating composition, which constitutes each of the layers, is applied onto a support and subsequently dried. In this case, it is possible to simultaneously apply at least two layers onto a support. Examples of coating methods which are preferably employed include a roller coating method, a rod bar coating method, an air knife coating method, a spray coating method, a curtain coating method, or an extrusion coating method using a hopper, described in U.S. Pat. No. 2,681,294.

Ink-jet ink (hereinafter also referred to simply as ink), which is employed to print images on the ink-jet recording sheet of the present invention, will now be described.

Employed as ink which is applied onto the ink-jet recording sheet of the present invention may be a water based ink composition, an oil based ink composition, and a solid (phase variation) ink composition. Of these, particularly preferably employed is the water based ink composition (for example, a water based ink-jet recording liquid incorporating-at least 10 percent water with respect to the total ink weight).

Employed as usable colorants in the ink may be conventional water-soluble dyes such as acid dyes or direct dyes, and disperse dyes, as well as pigments.

It is preferable that water-soluble organic solvents are simultaneously employed in the water based ink composition. Usable examples of such water-soluble organic solvents in the present invention include alcohols (for example, methanol, ethanol, propanol, isopropanol, butanol, isobutanol, secondary butanol, and tertiary butanol, pentanol, hexanol, cyclohexanol, and benzyl alcohol); polyhydric alcohols (for example, ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thioglycol); polyhydric alcohol ethers (for example, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, triethylene glycol monobutyl ether, ethylene glycol monophenyl ether, and propylene glycol monophenyl ether); amines (for example, ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamthyldiethylenetriamine, and tetramethylpropylenediamine); amides (for example, formamide, N,N-dimethylformamide, and N,N-dimethylacetamide); heterocycles (for example, 2-pyrrolidone, N-methyl-2-pyrrolidone, cyclohexylpyrrolidone, 2-oxazolidone, 1,3-dimethyl-2-imidazolidinone); and sulfoxides (for example, dimethylsulfoxide); sulfones (for example, sulfolane); urea, acetonitrile and acetone. Listed as preferred water-soluble organic solvents are polyhydric alcohols. Further, it is particularly preferred to simultaneously employ polyhydric alcohols and polyhydric alcohol ethers. Water-soluble organic solvents may be employed individually or in combinations of a plurality of them. The total addition amount of the water-soluble organic solvent in the ink is commonly 5-60 percent by weight, but is preferably 10-35 percent by weight.

If desired, in compliance with purposes to enhance various kinds of performance such as ejection stability, adaptability to ink heads and ink cartridges, storage stability, or image retention properties, it is appropriate to select and then use any of the conventional additives such as viscosity controlling agents, surface tension controlling agents, resistivity controlling agents, film forming agents, dispersing agents, surface active agents, UV absorbers, antioxidants, anti-fading agents, mildewcides, or corrosion inhibitors. Examples of the above include polystyrene, polyacrylic acid esters, polymethacrylic acid esters, polyacrylamides, polyethylene, polypropylene, polyvinyl chloride, polyvinylidene chloride, copolymers thereof, urea resins, minute organic latex particles of melamine resins, liquid paraffin, dioctyl phthalate, tricresyl phosphate, minute oil droplets, various cationic or nonionic surface active agents, UV absorbers described in JP-A Nos. 57-74193, 57-87988, and 62-261476, anti-fading agents described in JP-A Nos. 57-74192, 57-87989, 60-72785, 61-146591, 1-95091, and 3-13376, optical brightening agents described in JP-A Nos. 59-42993, 59-52689, 62-280069, 61-242871, and 4-219266, and pH controlling agents such as sulfuric acid, phosphoric acid, citric acid, sodium hydroxide, potassium hydroxide, or potassium carbonate.

The viscosity of ink compositions during ejection is preferably at most 40 mPa·s, but is more preferably at most 30 mPa·s. Further, the surface tension of the ink composition during ejection is preferably at least 20 mN/m, but is more preferably 30-45 mN/m.

Ink-jet heads which are employed in the ink-jet recording method employing the ink-jet recording sheets of the present invention may be of either an on-demand system or a continuous system. Further, listed as specific examples of the ejection system may be an electric-mechanical conversion system (for example, a single cavity type, a double cavity type, a vendor type, a piston type, a share mode type, and a shared wall type), an electric-thermal conversion system (for example, a thermal ink-jet type, and BUBBLE JET (a registered trade name) type, an electrostatic suction type (for example, an electrolysis controlling type and a slit jet type). However, it is possible to use any of these ejection systems.

### EXAMPLES

The present invention will be now described with reference to examples, however the present invention is not limited thereto. In the examples, “parts” or “%” is employed and represent “parts by weight” or “weight percent”, respectively, unless otherwise specified.

### Example 1

<<Preparation of Additives>>

(Synthesis of Colloidal Silica)

Based on the synthesis method described in the reference “Gypsum & Lime No. 211 (1987) pages 47-48”, Colloidal Silicas s-1 through s-5 at the average particle diameter described below were synthesized while appropriately controlling synthesis conditions, employing an ion exchange method using an aqueous sodium silicate solution.

S-1: average particle diameter of 15 nm

S-2: average particle diameter of 35 nm

S-3: average particle diameter of 45 nm

S-4: average particle diameter of 100 nm

S-5: average particle diameter of 130 nm

(Preparation of Minute Particle Dispersion A)

After, at room temperature, suction-dispersing 10 kg of vapor phase method silica (trade name: AEROSIL 200 at an average diameter of the primary particles of 14 nm, produced by Nippon Aerosil Co., Ltd.) into an aqueous solution prepared by adding 435 ml of ethanol to 35 L of pure water, employing JET STREAM INDUCTOR MIXER, produced by Mitamura Riken Kogyo Inc., the total volume was brought to 43.5 L by the addition of pure water, whereby a dispersion was prepared. The resulting dispersion incorporated ethanol in an amount of 1 percent by weight and exhibited a pH of 2.8.

Subsequently, 33 ml of 28 percent aqueous Cationic Polymer P-1 was added to 400 ml of the above dispersion, and the resulting mixture was pre-dispersed employing a dissolver. Then, triethanolamine was added in a necessary amount to control the pH to 4.5. Further, dispersion was conducted for 30 minutes at a peripheral rate of 9 m/second, employing a sand mill homogenizer. The total volume of the resulting dispersion was brought to 540 ml, whereby almost transparent Minute Particle Dispersion A was prepared. The resulting Minute Particle Dispersion A was filtered employing TCP-10 produced by Advantech Toyo, Ltd.

Cationic Polymer P-1 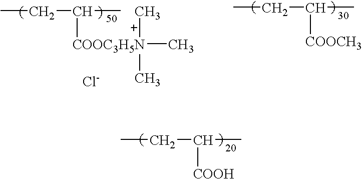
(Preparation of Aqueous Hydrophilic Resinous Solution B-1)

Based on the method described in JP-A No. 2000-181062, after allowing polyvinyl alcohol, at a degree of polymerization of 1,700 and a saponification ratio of 98 percent, to react with p-(3-methacryloxy-2-hydroxypropyloxy)benzaldehyde, a photopolymerization initiator (KAYACURE QTX, produced by Nippon Kayaku Co., Ltd.) was added in an amount of 1.8 percent in terms of a weight ratio with respect to polyvinyl alcohol, whereby Aqueous Hydrophilic Resinous Solution B-1, which was an aqueous ultraviolet radiation polymerizing type polyvinyl alcohol solution at a crosslinking group modification ratio of 1 mol percent and a solid concentration of 8 percent by weight, was prepared.

<<Preparation of Ink Absorptive Layer Liquid Coating Composition>>

(Preparation of Lower Layer Liquid Coating Composition 1)

While stirring at 40° C., added to 528 ml of Minute Particle Dispersion A prepared as above was 188 ml of Aqueous Resinous Solution B-1 prepared as above, and the total volume was brought to 1,000 ml by the addition of pure water, whereby translucent Lower Layer Liquid Coating Composition 1 was prepared.

(Preparation of Upper Layer (Uppermost Layer) Liquid Coating Composition 1)

Added to 321 ml of Aqueous Hydrophilic Resinous Solution B-1 prepared as above was 450 ml of pure water, and while stirring, 100 g of powder of vapor phase method silica (at an average particle diameter of 14 nm, under the registered trade name AEROSIL 200, produced by Nippon Aerosil Co., Ltd.). The resulting mixture was pre-dispersed employing a dissolver, and triethanolamine was then added in the amount to control the pH to 4.5. The resulting mixture was then dispersed for 20 minutes at a peripheral rate of 9 m/second employing a sand mill homogenizer. Subsequently, filtration was performed employing a TCP-10 type filter produced by Advantechs Toyo, Inc. Further, ratio (P/B) of microparticles (P) to hydrophilic resin (B), of Upper Layer Liquid Coating Composition prepared as above, was 3.5.

<<Preparation of Recording Sheets>>

(Preparation of Recording Sheet 1-1)

Aforesaid Upper Layer Liquid Coating Composition was applied onto a polyethylene-coated paper prepared by covering both sides of a 170 g/m² base paper with polyethylene (incorporating 8 percent anatase type titanium oxide on the ink absorptive layer side and also carrying a 0.05/m² gelatin layer on the ink absorptive layer side, and carrying 0.2 g/m² back layer incorporating latex polymers at a Tg of about 80° C. on the side opposite the ink absorptive layer) to result in a wet layer thickness of 200 μm, employing a wire bar. After coating, by employing a metal halide lamp having a dominant wavelength of 365 nm, ultraviolet radiation was exposed at an illuminance of 100 mw/cm² to reach an energy amount of 30 mJ/cm², followed by drying employing a hot air type oven at 80° C., whereby Lower Layer Coating Sample 1 was prepared. The surface of resulting Lower Layer Coating Sample 1 was observed employing an electron microscope based on the above method, and the determined average void diameter was 25 nm.

Subsequently, Upper Layer Liquid Coating Composition 1, prepared as above, was applied onto above Upper layer Coating Sample 1 to result in a dried layer thickness of 0.5 μm, employing a wire bar. After coating, by employing a metal halide lamp having a dominant wavelength of 365 nm, ultraviolet radiation was exposed at an illuminance of 100 mw/cm² to reach an energy amount of 30 mJ/cm², followed by drying employing a hot air type oven at 80° C., whereby Recording Sheet 1-1 was prepared. The surface of resulting Recording Sheet 1-1 was observed employing an electron microscope based on the above method, and the determined average void diameter was 15 nm.

(Preparation of Recording Sheets 1-2-1-15)

Recording Sheets 1-2-1-15 were prepared in the same manner as above Recording Sheet 1-1, except that the type of microparticles and ratio (P/B) of the microparticles to the hydrophilic resins, as well as the dried layer thickness employed in Upper Layer Liquid Coating Composition were replaced with those listed in Table 1. Incidentally, the pH of each upper layer liquid coating composition was controlled employing triethanolamine or nitric acid.

Each of the microparticles, represented by abbreviated designations in Table 1, is detailed below.

Microparticles A: vapor phase method silica (at an average secondary particle diameter of 41 nm, trade name: AEROSIL 200, produced by Nippon Aerosil Co., Ltd. (*: value determined by observing the surface employing an electron microscope after preparing the recording sheet))

Microparticles B: cation-modified colloidal silica (at an average particle diameter of 12 nm, trade name: SNOWTEX AK, produced by Nissan Chemical Industries, Ltd.)

Microparticles C: acidic colloidal silica (at an average particle diameter of 15 nm, trade name: SNOWTEX 0, produced by Nissan Chemical Industries, Ltd.)

Microparticles D: styrene-acryl copolymer emulsion (at an average particle diameter of 20 nm, and a ratio of styrene:n-butyl acrylate 4:1)

s-1-s-5: aforesaid colloidal silica

<<Evaluation of Recording Sheets>>

(Evaluation of Glossiness)

Specular gloss (60°) and image distinctness (at a reflection angle of 60°) of each recording sheet were determined based on the following methods. The glossiness was evaluated based on the following criteria. When the evaluation rank was at least 3, it was judged that the glossiness was near that of conventional silver salt photographic prints.

Specular gloss: By employing a variable angle photometer (VGS-10001DP), produced by NDK, Inc., specular gloss was determined at an incident angle and a reflection angle of 60°.

Image distinctness: The image distinctness specified in JIS K 7105 was determined in terms of image clarity (C value percent) at a reflection of 60° and an optical comb of 2 mms, employing an image clarity meter ICM-1DP (produced by Suga Test Instruments Co., Ltd.).
5: specular gloss was 75-100, while image distinctness was 75-99
4: specular gloss was 75-100, while image distinctness was 65-75
3: specular gloss was 60-74, while image distinctness was 56-65
2: specular gloss was 60-74, while image distinctness was 45-55
1: specular gloss was 30-60, while image distinctness was 20-45
   (Evaluation of Ink Absorbability)

A solid green image was printed on each of the recording sheets prepared as above by the genuine ink, employing an ink-jet printer PM-800 produced by Seiko Epson Corp. Immediately after printing, the resulting green image was rubbed with fingers and any resulting image deterioration was visually evaluated. Subsequently, ink absorbability was evaluated based on the following criteria.
A: even though rubbed with fingers, no image deterioration was noted
B: when rubbed with fingers, the image resulted in slight image deterioration, but the resulting quality was fully commercially viable
C: when rubbed with fingers, the image was slightly stained due to rubbing, but was in the range of commercial viability
D: when the image was rubbed, it resulted in marked staining and exhibited a quality well below the commercial viability
   (Evaluation of Dot Magnification Ratio)
   Preparation of Ink Liquid)

A black ink, comprising the compositions described below, was prepared.

| | |
|---|---|
| C.I. Direct Yellow 86 | 3 parts by weight |
| C.I. Reactive Red 80 | 2.6 parts by weight |
| C.I. Direct Blue 199 | 2.5 parts by weight |
| Ethylene glycol | 22 parts by weight |
| Propylene glycol | 14 parts by weight |
| 2-Methyl-2,4-pentanediol | 10 parts by weight |
| Surface Active Agent | 0.05 part by weight |
| (EMULGEN, produced by | |
| KAO Corp.) | |
| PROXEL GXL (produced by | 0.1 part by weight |
| Avicia Co.) | |
| Ion-exchanged water | 45.75 parts by weight |

(Ink-Jet Image Recording)

While employing the ink-jet head using the piezoelectric ceramic described in JP-A No. 11-99644, recording was performed onto each recording sheet employing the ink liquid prepared as above under conditions of a recording density of 70 dpi (being the number of dots per 2.54 cm), a driving frequency of 30 kHz, and an ink droplet volume of 7 pl, and the following evaluation was performed.

(Determination of Dot Magnification Ratio)

Dots on the resulting recorded image were magnified and captured employing a microscope to which a CCD camera was attached. The diameter of each of 30 dots was determined and the average value was obtained. The dot diameter of Recording Sheet 1-2 was specified to 1.0, and the ratio of the dot diameter of each of the other recording sheets was obtained. The resulting ratio was designated as the dot magnification ratio.

Table 1 shows the results.

TABLE 1

| | Uppermost Layer | | | | Individual Evaluation | | | |
|---|---|---|---|---|---|---|---|---|
| | Constitution | | | | Result | | | |
| Recording | | | Layer | | | | Dot | |
| Sheet | | | Thickness | | | Ink | Magnification | |
| No. | Microparticles | P/B | (μm) | *1 | Glossiness | Absorbability | Ratio | Remarks |
| 1-1 | Microparticles A | 3.5 | 0.5 | 15/25 | 4 | B | 1.13 | Inv. |
| 1-2 | Microparticles A | 6.0 | 0.5 | 25/25 | 3 | A | 1.00 | Comp. |
| 1-3 | Microparticles A | 10.0 | 0.5 | 29/25 | 2 | D | 1.00 | Comp. |
| 1-4 | S-2 | 10.0 | 0.5 | 8/25 | 4 | A | 1.19 | Inv. |
| 1-5 | Microparticles B | 10.0 | 0.5 | 3/25 | 5 | A | 1.25 | Inv. |
| 1-6 | S-1 | 10.0 | 0.5 | 3/26 | 5 | A | 1.20 | Inv. |
| 1-7 | Microparticles C | 10.0 | 0.5 | 3/27 | 5 | A | 1.23 | Inv. |
| 1-8 | Microparticles D | 10.0 | 0.5 | 3/28 | 5 | A | 1.17 | Inv. |
| 1-9 | Microparticles B | 10.0 | 0.02 | 3/25 | 5 | A | 1.10 | Inv. |
| 1-10 | Microparticles B | 10.0 | 0.03 | 3/25 | 5 | A | 1.16 | Inv. |
| 1-11 | Microparticles B | 10.0 | 1.0 | 3/25 | 5 | A | 1.25 | Inv. |
| 1-12 | Microparticles B | 10.0 | 1.4 | 3/25 | 5 | A | 1.24 | Inv. |
| 1-13 | S-3 | 9.0 | 0.5 | 8/25 | 5 | A | 1.16 | Inv. |
| 1-14 | S-4 | 6.0 | 0.5 | 8/25 | 5 | A | 1.14 | Inv. |
| 1-15 | S-5 | 4.0 | 0.5 | 8/25 | 4 | A | 1.13 | Inv. |

*1: Void Diameter (nm) Ratio Upper Layer/Lower Layer,
Inv.: Present Invention,
Comp.: Comparative Example

As can clearly be seen from the results described in Table 1, compared to Comparative Examples, the recording sheets of the present invention resulted in better dot magnification effect and exhibited an desired glossiness and excellent ink absorbability.

### Example 2

<<Preparation of Additives>>

(Preparation of Minute Particle. Dispersion B)

After, at room temperature, suction-dispersing 10 kg of vapor phase method silica (trade name: AEROSIL 200 at an average diameter of the primary particles of 14 nm, produced by Nippon Aerosil Co., Ltd.) into an aqueous solution prepared by adding 435 ml of ethanol to 35 L of pure water, employing JET STREAM INDUCTOR MIXER, produced by Mitamura Riken Kogyo Co., Ltd., the total volume was brought to 43.5 L by the addition of pure water, whereby a dispersion (at a pH of 2.8, incorporating 1 percent by weight of ethanol) was prepared. The resulting dispersion incorporated ethanol in an amount of 1 percent by weight and exhibited a pH of 2.8.

Subsequently, 33 ml of 28 percent aqueous Cationic Polymer P-1 (described above) and 69 ml of an aqueous solution, in which 2.1 g of boric acid and 1.4 g of borax had been dissolved, was added to 400 ml of the above dispersion, and the resulting mixture was pre-dispersed employing a dissolver. Further, dispersion was conducted for 30 minutes at a peripheral rate of 9 m/second, employing a sand mill homogenizer. Thereafter, the total volume of the resulting dispersion was brought to 540 ml, whereby an almost transparent Minute Particle Dispersion B was prepared. The resulting Minute Particle Dispersion B was filtered employing TCP-10 produced by Advantechs Toyo, Ltd.

<<Preparation of Recording Sheets>>

(Preparation of Recording Sheet 2-1)

Added to 125 ml of an 8 percent aqueous polyvinyl alcohol (trade name: PVA235, produced by Kuraray Co., Ltd.) solution was 200 ml of pure water. Subsequently, while stirring, 556 ml of 18 percent dispersion (trade name: SNOWTEX SK, produced by Nissan Chemical Industries, Ltd.) of a cation-modified colloidal silica, as the source of microparticles, was added. After dispersing the resulting mixture, employing a dissolver, nitric acid was added in an amount to control the pH to 4.5. Subsequently, dispersion was conducted for 20 minutes at a peripheral rate of 9 m/second. Filtration was conducted employing a TCP-10 type filter produced by Advantechs Toyo, Ltd., whereby Upper Layer Liquid Coating Composition 16 was prepared. Further, 3 g of glyoxal as a crosslinking agent was added to Upper Layer Liquid Coating Composition 16. The resulting mixture was applied onto Lower Layer Coating Sample 1 to result in a dried layer thickness of 0.5 μm employing a wire bar. After coating, drying was carried out employing a hot air type oven at 80° C., whereby Recording Sheet 2-1 was prepared.

(Preparation of Recording Sheets 2-2 and 2-3)

Recording Sheet 2-2 was prepared in the same manner as above Recording Sheet 2-1, except that Upper Layer Liquid Coating Composition 16 was replaced with Upper Layer Liquid Coating Composition 17, in which the amount of glyoxal was changed to 1 g, while Recording Sheet 2-3 was prepared in the same manner as above Recording sheet 2-1, except that glyoxal was replaced with diglycidyl ether.

(Preparation of Recording Sheet 2-4)

Added to 125 ml of an 8 percent aqueous polyvinyl alcohol (trade name: PVA235, produced by Kuraray Co., Ltd.) solution was 200 ml of pure water. Subsequently, while stirring, 556 ml of an 18 percent dispersion (trade name: SNOWTEX SK, produced by Nissan Chemical Industries, Ltd.) of cation-modified colloidal silica as the source of microparticles, was added. Further, 42 ml of an aqueous solution, in which 1.4 g of boric acid and 0.8 g of borax were dissolved, was added, and the resulting mixture was dispersed employing a dissolver. Subsequently, the resulting dispersion was further dispersed for 20 minutes at a peripheral rate of 9 m/second, employing a sand mill homogenizer. Filtration was then carried out employing a TCP-10 type filter produced by Advantech Toyo, Ltd., whereby Upper Layer Liquid Coating Composition 19 was prepared. Above Upper Layer Liquid Coating Composition 19 was applied onto Upper Layer Coating Sample 1 to result in a dried layer thickness of 0.5 μm, employing a wire bar. After coating, drying was performed employing a hot air type oven at 80° C., whereby Recording Sheet 2-4 was prepared.

(Preparation of Recording Sheets 2-5 and 2-6)

(Preparation of Lower Layer Liquid Coating Composition 2)

While stirring at 40° C., gradually added to 528 ml of Minute Particle Dispersion B described in Example 1, was 188 ml of an 8 percent aqueous solution of polyvinyl alcohol (trade name: PVA235, produced by Kuraray Co., Ltd.). Subsequently, the total volume was brought to 1,000 ml by the addition of pure water, whereby translucent Lower Layer Liquid Coating Composition 2 was prepared.

(Preparation of Recording Sheet 2-5)

Aforesaid Lower Layer Liquid Coating Composition 2 was applied onto a polyethylene-coated paper prepared by covering both sides of a 170 g/m² paper base with polyethylene (incorporating 8 percent anatase type titanium oxide on the ink absorptive layer side and also carrying a 0.05/m² gelatin layer on the ink absorptive layer side, and carrying 0.2 g/m² back layer incorporating latex polymers at a Tg of about 80° C. on the side opposite the ink absorptive layer), to result in a wet layer thickness of 200 μm, employing a wire bar. After coating, drying was performed employing a hot air type oven at 80° C., whereby Lower Layer Coating Sample 2 was prepared. The surface of resulting Recording Sheet 2 was observed employing an electron microscope based on the above method, and the determined average void diameter was 23 nm.

Subsequently, Upper Layer Liquid Coating Composition 5 employed to prepare Recording Sheet 1-5 was applied onto Lower Layer Coating Sample 2 to result in a dried layer thickness of 0.5 μm, employing a wire bar. After coating, by employing a metal halide lamp having a dominant wavelength of 365 nm, ultraviolet radiation was exposed at an illuminance of 100 mw/cm² to reach an energy amount of 30 mJ/cm², followed by drying employing a hot air type oven at 80° C., whereby Recording Sheet 2-5 was prepared.

(Preparation of Recording Sheet 2-6)

Upper Layer Liquid Coating Composition 19 employed to prepare Recording Sheet 2-4 was applied onto Lower Layer Coating Sample 2 to prepare Recording Sheet 2-5 to result in a dried layer thickness of 0.5 μm employing a wire bar. After coating, drying was performed employing a hot air type oven at 80° C., whereby Recording Sheet 2-6 was prepared.

<<Evaluation of Recording Sheets>>

Each of the recording sheets prepared as above, as well as each of Recording Sheets 1-5 prepared in Example 1, were evaluated in the same manner as for Example 1, and also evaluated was layer surface cracking based on the method below. Further, the dot magnification ratio was evaluated for each of the samples stored under three conditions of (60° C. for 5 hours), (60° C. for 14 days), and (60° C. for 30 days) The average void diameter determined by electron microscopic observation of the surface of each of the recording sheets was in the range of 3-6 nm.

(Evaluation of Cracking Resistance)

The number of at least 5 μm cracks per 10 cm×10 cm of each of the recording sheets was recorded, whereby cracking resistance was evaluated based on the following criteria.

In the following evaluation rank, C was within the lower commercially viable limit in terms of image quality, while D was beyond the commercially viable limit.

A: no crack was noted

B: 1-3 cracks were noted

C: 4-9 cracks were noted

D: at least 10 cracks were noted

Table 2 shows each of the evaluation results.

TABLE 2

| Recording | Dot Magnification Ratio | | | | | | |
|---|---|---|---|---|---|---|---|
| Sheet | 5 Hours | 7 Days | 30 Days | Ink | Cracking | | |
| No. | at 60° C. | at 60° C. | at 60° C. | Absorbability | Resistance | Glossiness | Remarks |
| 1-5 | 1.25 | 1.25 | 1.26 | A | A | 5 | Inv. |
| 2-1 | 1.25 | 1.14 | 1.13 | A | A | 2 | Comp. |
| 2-2 | 1.26 | 1.20 | 1.21 | B | A | 2 | Comp. |
| 2-3 | 1.24 | 1.13 | 1.11 | A | A | 2 | Comp. |
| 2-4 | 1.23 | 1.10 | 1.09 | B | C | 2 | Comp. |
| 2-5 | 1.24 | 1.22 | 1.22 | A | B | 4 | Inv. |
| 2-6 | 1.23 | 1.08 | 1.07 | D | C | 1 | Comp. |

Inv.: Present Invention,
Comp.: Comparative Example

As can clearly be seen from the results described in Table 2, recording sheets of the present invention tended to exhibit no cracking, resulted in high dot magnification effect and exhibited the desired glossiness as well as desired ink absorbability, compared to the comparative example.

Specifically, in the case of incorporation of hydrophilic resins which had undergone crosslinking by ionization radiation, it was seen that even after storage of recording sheets, stable dot magnification effect was obtained.

What is claimed is:

1. An ink-jet recording sheet comprising a support having thereon at least two porous ink absorptive layers comprising microparticles and a hydrophilic resin,
wherein an uppermost ink absorptive layer has a smaller average void diameter than an ink absorptive layer adjacent to the uppermost ink absorptive layer, and the hydrophilic resin in the uppermost ink absorptive layer is cross-linked by irradiation with ionization radiation.

2. The ink-jet recording sheet of claim 1,
wherein a thickness of the uppermost ink absorptive layer is from 0.03 to 1.00 μm.

3. The ink-jet recording sheet of claim 1,
wherein the hydrophilic resin in the uppermost ink absorptive layer has a degree of polymerization of not less than 300 and comprises a main chain and a plurality of side chains, and the side chains are cross-linked with each other by irradiation with ultraviolet radiation.

4. The ink-jet recording sheet of claim 1,
wherein an average particle diameter of the microparticles in the uppermost ink absorptive layer is not more than 100 nm, and the microparticles are silica or a polymer.

5. The ink-jet recording sheet of claim 4,
wherein the microparticles in the uppermost ink absorptive layer are colloidal silica.

6. The ink-jet recording sheet of claim 1,
wherein the uppermost ink absorptive layer is produced by a method comprising the steps of:
(a) applying an ink absorptive layer composition comprising the microparticles, hydrophilic resin and a solvent onto the support;
(b) irradiating the applied ink absorptive layer composition with ionization radiation while the applied ink absorptive layer composition is wet; and
(c) drying the irradiated ink absorptive layer composition.
